(19) United States
(12) Patent Application Publication
(10) Pub. No.: US 2016/0342690 A1
(43) Pub. Date: Nov. 24, 2016

(54) COMPUTER ARCHITECTURE AND NETWORK FOR CUSTOMIZING THE CONTENT OF PUBLICATIONS AND MULTIMEDIA

(71) Applicant: TIMOTHY J. YOUNG, NEW ORLEANS, LA (US)

(72) Inventor: TIMOTHY J. YOUNG, NEW ORLEANS, LA (US)

(21) Appl. No.: 15/159,757

(22) Filed: May 19, 2016

Related U.S. Application Data
(60) Provisional application No. 62/163,491, filed on May 19, 2015.

(51) Int. Cl. G06F 17/30; G06F 17/21

(52) U.S. Cl. CPC G06F 17/30864; G06F 17/212

(57) ABSTRACT

The invention provides for a computer architecture for managing publication of books and multimedia for plurality of subscribers, which include parents, school administrators and teachers, caregivers, vocational educators, and students. In one embodiment, a subscription service for children's publications in the form of hard copy print-on-demand, eBooks and multimedia, etc., is provided where the content periodically changes as a function of the child's growth, dependent on the child's age, emotional and intellectual status, and optionally subject matter, as determined by a subscriber.

### CROSS-REFERENCE TO RELATED APPLICATIONS

This application claims the benefit of provisional patent application Ser. No. 62/163,491 filed on May 19, 2015, the entire disclosure of which is hereby incorporated by reference.

### FIELD OF INVENTION

The present invention relates generally to computer architecture, software systems and networks for creating a subscription service for publications in the form of hard copy print-on-demand, eBooks and multimedia.

### BACKGROUND

Content used in books and multimedia do not contain serialized, changing scenarios, that may be relocated into books and multimedia (in part like a spiral notebook, such as may be supported by plotlines, with serialized editions, or changing content over time as a consequence of social, economic events (e.g., news, and legal updates)), so that which content may be distributed according to a fixed schedule, life event, or interest, occurring in an individual's life, education or vocation. For example, no known children's content, found in books or multimedia, allow parents to log into a computer system, establish a profile of their child, based 130 on age, demographics or interests, and select life objective or life events, or how deal with issues that may apply to their child, and then have articles, blogs, videos, slide show presentations, concerning such events or issues appear in a customized story of future content for that particular child. Such a system may be applied to other activities beyond a child learning experience, such as progressive training for a vocation, profession, or for learning a language.

Using the example of a child's learning experience, a parent must now search for a book or multimedia, which might happen to include life event, or issue within a story line, relevant to their child's circumstance (age, domicile, educational objective), then purchase the book or multimedia, and then read or watch it with their child, so as to then enrich, enhance or facilitate learning or communication about the event or issue. No known children's learning product exists, where as the child develops, the subject matter sought after is updated specific to the child's interest and other profile attributes, and incorporated into the child's library of books or multimedia, so as the child's library remains current and suitable to the child's level of maturity and interest.

The disclosed invention overcomes the forgoing limitations using a special computer system architecture and network by automatically determining if a subject matter is relevant to an individual's profile, and assembling in real-time content specific material, which may include one or a combination of one or more of originally created topic specific content and templates, printed media sources whether in printed or electronic form, such as books, stories, articles, reports, or visual arts, such as artwork, designs, videos, games, movies, plays, dramatizations, or music or other modes of expression, essential for the well-being and development of the child.

### SUMMARY OF THE INVENTION

This invention provides for a computer architecture, network and system that selects or assembles and creates, from a library of media content according to a set of user or default parameters concerning a child, by way of example and not limitation, a child's age, gender, religion, ethnicity, country of birth, country of residence, language, emotional and intellectual maturation, and may also include additional parameters by way of example, concerning one or more caregivers such as marital status or gender, or social, local or economic influences such as number, age and gender of siblings, and household demographics, and delivers the selected, or newly assembled and created content as new content in the form of an active project, and thereafter, periodically delivering additional new content in the form of an updated active project based on user or default parameters. In addition to selecting or creating content from one or more media sources, the network thereby distributes the content in the form of an eBook, print-on-demand publication, and/or multimedia.

The invention allows for customization of subject matter such that the content may include and address life events or issues such as the birth of a sibling, the first day of school, the death of a close relative, making or leaving friends, health and wellness, and other common topics and issues that arise as a child psychologically matures and physically develops. As a child ages, the content, whether academic, non fiction or fictional, may be configured to maintain an age-specific relevancy.

Moreover, the invention herein also relates to a computer-based subscription service, which delivers print or electronic content to a reader or viewer on a regular basis, based upon information regarding the intended user, such as gender, age, proficiency, optional factors related to the child's emotional and intellectual status, other relevant demographic data, current events, and optionally current subject matter, as determined by the subscriber. The subscriber selects the relevant events or topics, which then are included in future content such that the subscriber may address health and wellness, educational, social, cultural, and personal events or other topics relevant to the child. Based on the foregoing selection and stored information, the subscription service generates content for a reader or consumer of the material, based upon algorithms and other logical rules that made part of the invention, to insure that only relevant subject matter is accessed and properly assembled into a document or multimedia presentation, specific to an identifiable individual, such as a child.

In its most basic form, the material mirrors and tracks, by adding, inserting, updating and deleting subject matter, as in the case of a child, the progressive physical age of the child. For example, when the subject matter, such as a story plot begins, the main character might be the same physical age as the child. The parent may read such story to the child, or together parent and child may watch a video, on a regular basis. As the child grows older and enters school, the main character in the story may also enter school. In this way, the parent by reading a book or watching a video with the child, invites dialogue with the child about the events occurring in the child's life, as seen through the eyes of the main character. If a subscriber chooses to begin the subscription when their child is older, than the beginning age of the story line, the content would be adjusted so as to appear appropriate for the child's age at that time. An alternate embodiment also considers the developmental age of a child, which may differ from physical age especially in children who may have special needs or who may be deemed to be more developmentally advanced than their physical age or “gifted”, or children who have a physical or mental injury, impairment or disability. These children may have different needs and thus, the delivered media content can be tailored to meet the needs of the subscriber, accordingly.

In one embodiment, the computer architecture, network and system would provide for one or more ‘assimilation’ periods, such as several months, of content generated to allow for a story plotline to introduce characters, make logical categorizations and connections, and flow naturally to the newly subscribed parent.

In another embodiment of the invention, one of the characters in the story line follows the life events of the child, for example, as the child begins to express itself, such as verbally, so does the character. By way of example, a character may experience a first day of school and desires to participate in a creation of that event via a dialogue present within the content of the book. In yet other examples, the child may desire to understand how its book or multimedia character makes friends at school. If the content takes the form of a book, the child may choose a part in the book to read, perhaps as the main character begins to speak. The child may also read the book with the parent with the child reading the part of the main character, and alternatively, as the main character speaks.

In another embodiment of the invention, discussion questions and topics are added at the end of each defined period, (e.g., monthly) content, whereby the parent can discuss and answer such questions with the child. These talking points or questions open the door for dialogue about the issues raised in that period's content. They may take the form of open ended questions such as “What would you have done if you were [the main character] faced with the challenge he faced?” If the content were electronically delivered, the questions may be answered online and then collected and shared among all the subscribers, so the parent and child can read and discuss other answers or comments to the questions or discussion points for that period (e.g., month).

Under one embodiment of the invention, the parent may elect to subscribe to such discussion questions or topics or elect not to, and this would control whether such questions appeared at the end of the periodic content.

In yet another embodiment of the invention, all of the content of the publication or multimedia would be used in a school setting, and the teacher/school administration would be able to select the periodic (e.g., monthly) life events or issues to insert into a book for open classroom or at home discussion. This would allow the story plotline to be created ahead of time for the child, with such life events or issues being conveyed to the parent or primary caregiver as the case may be, so they are aware of what will appear in the story line for that particular issue. The answers to discussion questions or topics can then be done in the classroom or at home, with the caregiver involvement, and compiled for discussion in the classroom or at home.

Another embodiment of the invention relates to a non-transitory computer-readable medium for execution by a processor including code for: (a) assembling user specific data, based upon one or more user determined parameters, to select media content from a media library for creating one or more of a book, multimedia presentation or 3-D printed product; (b) storing the user specific data in a first database; (c) storing content related to the user specific data in a second database; (d) storing the media library content in a third database; (e) loading a media application having a plurality of tools into one or more computers; (f) using a manager tool from the media application to select from the media library content, specific media content based on the user determined parameter, for assembling the content into one or more active products; (g) loading, assembling and storing into a fourth data base, an active project from the user specific data and the specific media content; (h) delivering the active project to the user as one or more of a book, multimedia presentation or 3-D printed product (i) using a manager tool to update the active project based upon one or more user defined or program default parameters.

In still another embodiment of the invention, seasonal items may be introduced such as new toys that the main character receives at a significant holiday, birthday or other event. Optionally the toys or other items that have relevance to a story plotline can be created, via 3-D printing, or manufactured by a third party and sold to the subscriber, consistent with what the child read, viewed or heard, about in a story plotline. An online embodiment also allows subscribers to purchase books and materials in Braille, and access to online games and multimedia, related to the story plotline.

In still another embodiment of the invention includes a method for creating one of a book, multimedia presentation or 3-D printed product, utilizing the steps of: storing user specific data in a first database; storing content related to the user specific data in a second database; storing a library of content information in a third database; loading a media application having a plurality of tools into the one or more computers; using a manager tool from the media application to load media content for creating an active products into a database from user specific data and library of content information; assembling the active products into one or more of a book, multimedia presentation or 3-D printed product; and updating content of the book, multimedia or 3-D printed product, by searching additional resource information.

In yet another embodiment relates to a computer system for creating one of a book, multimedia presentation or 3-D printed product, including: one or more computers, and one or more storage devices containing databases associated thereto, including a user specific database; an active projects database; a library of content information database; a related content database; a web crawler to search and store new information into the related content database; a processor for determining if the new information, based on data in the user specific database, must update the active projects database; a manager tool to load media content for creating from an updated active projects database, one or more of a book, multimedia presentation or 3-D printed product; a media application having a plurality of tools for the one or more computers to assemble, display and distribute one of the book, multimedia presentation or 3-D printed product.

### BRIEF DESCRIPTION OF THE DRAWINGS

FIG. 1 is a block diagram of a computer architecture and system for a subscription service, which delivers print or electronic content on a regular basis to a subscriber, based upon information regarding the individual consumer, in accordance with an embodiment of the present invention.

FIG. 2 is a flowchart illustrating various steps in a method of computer-based creation and subscription service, for print or electronic content for an individual on a regular basis, based upon profiles and objectives regarding the individual, in accordance with an embodiment of the present invention.

FIG. 3 is a flowchart illustrating various steps in a method of computer-based creation and subscription service, for print or electronic content for an individual on a regular basis, based upon profiles and objectives regarding the individual, in accordance with an embodiment of the present invention.

FIG. 4 is a chart illustrating three categories of items used to form profiles, and other database records, to determine the type of content that a library assembles, and stores for inclusion into books and multimedia, in accordance with an embodiment of the present invention.

FIG. 5 is a block diagram of a computer architecture and system for accessing Internet information based on relevancy to information resident in a profile of an individual, an based on the relevancy, updating of a book, multimedia or producing a 3-D product, in accordance an embodiment of the present invention.

### DETAILED DESCRIPTION OF THE INVENTION

In the figures to be discussed, the blocks and arrows represent architectural, system features, functions and processes according to embodiments of the invention, which may be implemented as computers, networks of computers, application specific processors, computer executable code, and/or electrical circuits and associated wires or data buses, which transport electrical signals. Alternatively, one or more associated arrows may represent communication (e.g., data flow) between networks, databases and software routines, particularly when the present method or apparatus of the present invention is implemented as a digital process.

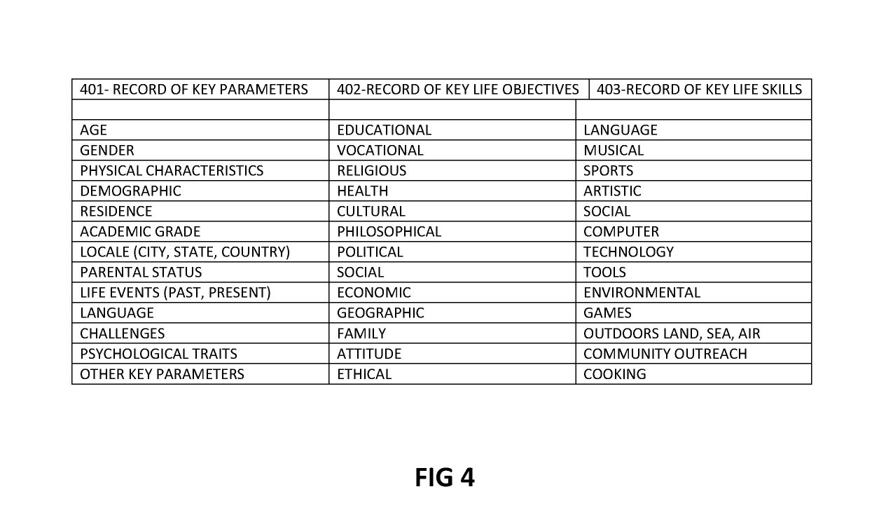

As indicated above, the invention relates generally to an acquisition of information, a test for relevancy of the material based on an individual's profile, creating a book, such as a notebook, or other multimedia presentation, and deliver of the subject matter via a subscription service as determined by a subscriber, wherein the content of the subject matter periodically changes as a function of a consumer's (such as a reader's) growth, physical and psychological, characteristics, and other information, such a by way of example listed in FIG. 4.

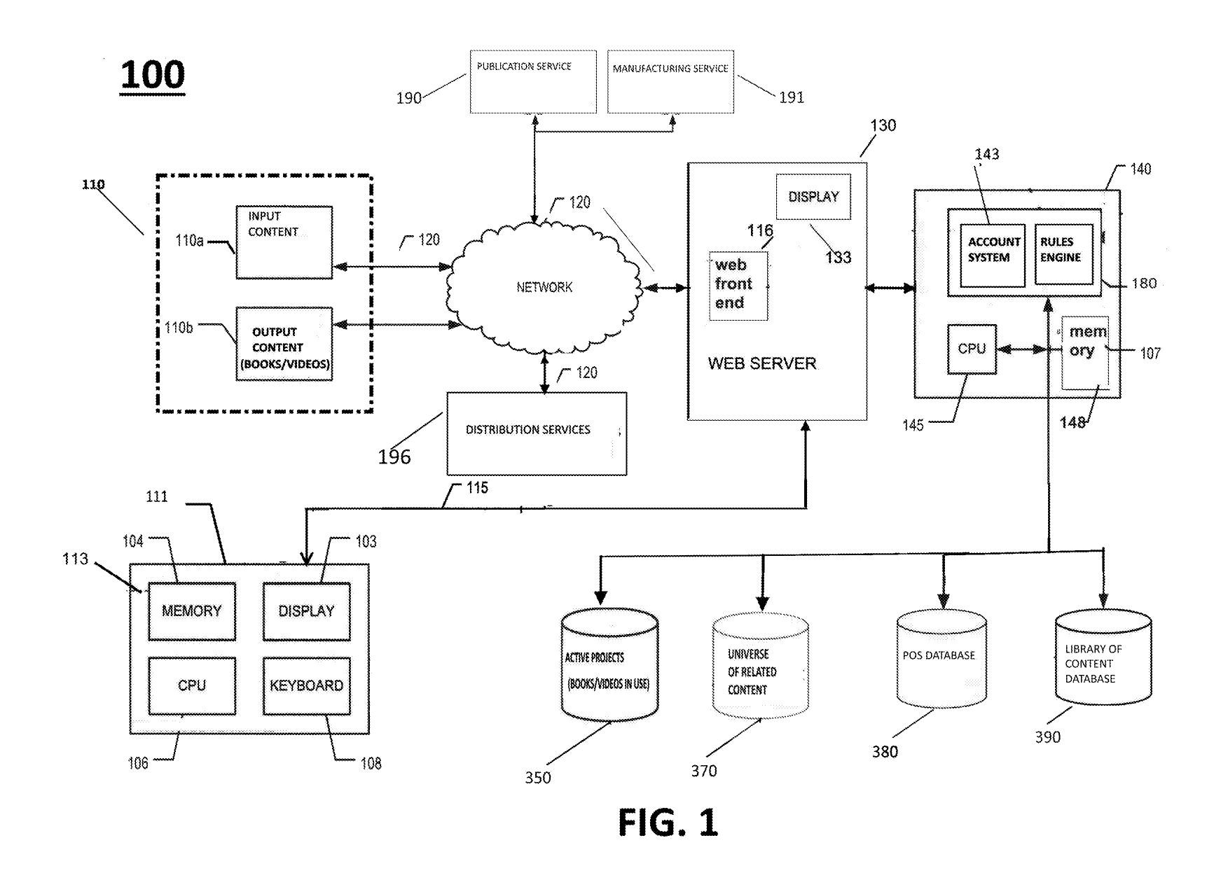

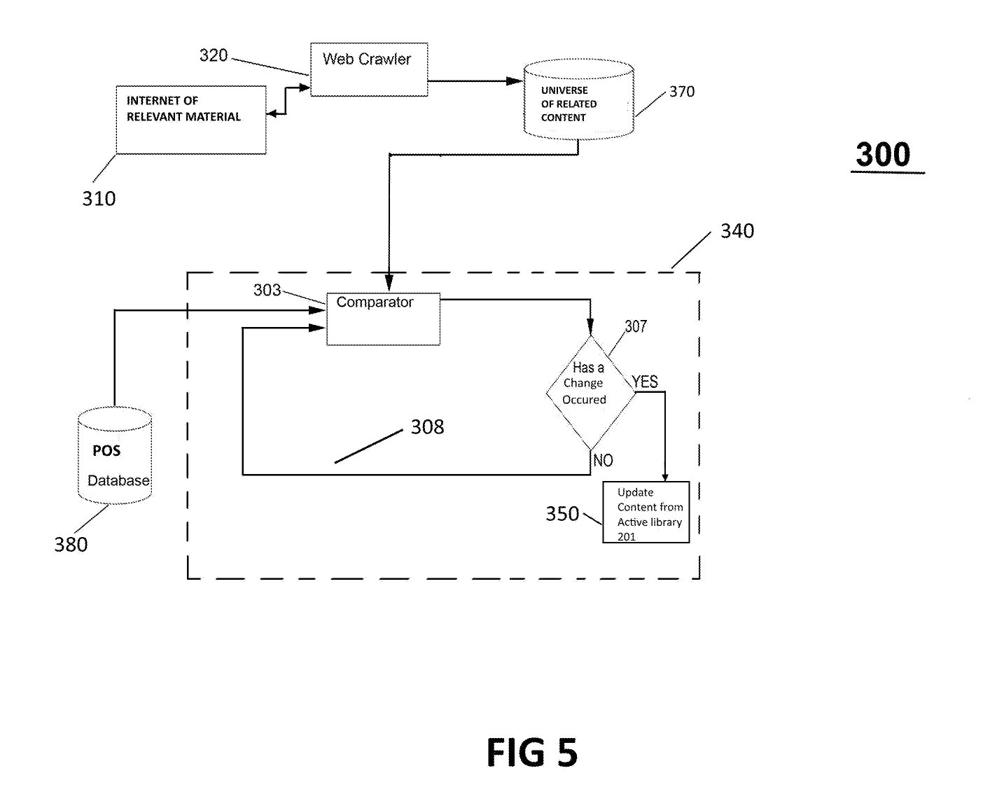

In one embodiment of the invention, the computer architecture and system described in FIG. 1, facilitates the creation of a work, (e.g., a book, multimedia presentation, or 3-D product), otherwise impossible on a large scale, dependent an individual's preferences, and development, such as by way of example, factors list in FIG. 4. The computer system includes: one or more computers as depicted by reference to 110, 111, 130, and 140, and one or more storage devices containing databases associated thereto, including a user specific database 380; an active projects database 350; a library of content information database 390; a related content database 370; a web crawler (FIG. 5) to search and store new information into the related content database 370; a processor (FIG. 5) for determining if the new information, based on data in the user specific database, must update the active projects database 350; a manager tool, generally located in processor 140, to load media content for creating from an updated active projects database (350); one or more of a book, multimedia presentation or 3-D printed product; a media application, generally located in processor 140, having a plurality of tools for the one or more computers to assemble, display and distribute one of the book, multimedia presentation or 3-D printed product.

The system 100 allows a subscriber 110 to log into a terminal 110a and input content, which may consist of web pages, via URL addresses, or other content, and upload photos, and other writings, as well as the key in parameters, objectives and skills, as illustrated in FIG. 4. The input, uploads and keyed in information is used by the system (specific architecture and network) to create, edit, modify, a book or multimedia presentation. Terminal 110b provides a private secure electronic means to view any content, based on the subscriber 110 inputs and to select other options, such as requests for the delivery of a publication or multimedia presentation, such as a video.

The subscriber in using terminal 110a employs various graphical user interfaces (GUI) having thereon menu options to alter the content of a publication or multimedia presentation, (e.g., a video) resident in the content provider's system of active products 350, i.e., the actual content of a book or multimedia presentation at any point in time, for which the subscriber has been permitted access, based on various subscription plans. Alternatively, the subscriber in using terminal 110a employs various GUI having therein menu options to assemble new content from the universe of related content 370 and the library of content 390. Altered content and newly assembled content are stored in the active project database 350 and accessible on demand. Utilizing the web server 130, with a display 133 and a front end 116 (e.g., router, modem) connected to a network, such as the Internet or an intranet, the content provider, such as a publisher, logs into terminal 111, to administrate and to view all data, including a library of content, templates and reference materials in database 390, active projects in database 350. In another embodiment of the invention, the subscriber active products database 350 and the library of content data 390 is updated automatically via algorithms and rules, as more fully described with reference to FIG. 5, below.

The library of content 390 comprises the material culled from a network of resources, such as libraries at several virtual or actual locations, templates, genre, categories, such as bibliographic items, from any information entity (e.g., books, computer files, graphics, cartographic materials, multimedia files, audio files, etc.) that is considered library material (e.g., a single novel or story in an anthology), or a group of library materials (e.g., a trilogy), or linked from a catalog (e.g., a webpage), as far as it is relevant to the user's particular catalog, upon which the books, audio and multimedia presentations, (e.g., videos) will be created, edited, updated, assembled and distributed. In one embodiment, the overall content provider, as publisher logs into terminal 111, to push publisher content to one or more of the universe of related content 370 and library of content database 390.

By way of illustration, the story of The Three Bears, may be resident in the library of content 390, and include a variable, such as age, where the age and behavior of the youngest bear can be altered in accordance with a rules engine, 180, that takes into account the desires, parameters and the user's objectives as illustrated, by way of example, in FIG. 4. Thus for a child of four years old, the youngest bear might seem itself as young and as large as the child. As the child grows the picture of the bear can illustrate a larger bear, and its speech pattern might change as will to reflect that the bear is maturing.

Further, using input device 110a, the system allows each logged-in subscriber to input data, as illustrated in FIG. 4, such as gender, age, optional factors related to a child's emotional and intellectual status, other relevant demographic data, current events, and optionally current subject matter. The system 100 also allows for the automatic computer generation of the publication or multimedia presentation, such as a video, by utilizing a publication service 190, for electronically pulling in certain data and factors relevant thereto, all available within the computer system, including, but not limited to, subscriber's selected life events or issues, which then are included in future content, such that by way of example, a parent, teacher, home school education provider, child care provider, may address educational, social, cultural, and personal events or issues deemed relevant to the ultimate user, i.e., reader or viewer, such as a pre-school child, student, or employee.

System 100 further allows for the uploading of all required documentation, including documentation to an output content 110b terminal of each publication or multimedia presentation. The output of content allows for the optional printing of publications, including eBook display, at the subscriber's site on terminal 110. In the event that the subscriber using terminal 110 does not desire to receive the publications or multimedia via the output content terminal 110b, then the publication services delivers the content to the distribution services 196 for hard copy printing or multimedia recording, and distributes the content to the subscriber via mail-type service, US postal, UPS, etc.

In general, FIG. 1, system 100, includes an innovative network for achieving the objectives of the invention, such as a local area network (LAN) of terminals or workstations, database file servers, input devices (such as keyboards and document scanners) and output devices configured by software (processor executable code or application specific processors (hardware, firmware, and/or combinations thereof), for accumulating, processing, administering, creating, printing and distributing the publication or multimedia.

The system 100 provides for calculating the publication or multimedia costs, preparing invoices and sending out bills on a periodic basis, and additionally provides for electronic data transfer pertaining to administrative data, and billing via account system 143, which further allows for receipt of payment for the service by subscribers. The system via accounting system 143 also allows for the electronic dissemination of terms and conditions, and receipt of the execution of contractual documents, for the underlying commercial transaction, ordering or requesting quotes for a specified publication or multimedia.

The features of system 100 may be implemented in a system of computer peripherals that communicatively couple to various types of networks, such as a wide area networks and the global interconnection of computers over private networks, and computer networks commonly referred to as the network 120. If network 120 is an intranet, then the intranet connects to the World Wide Web, such as the Internet. Otherwise, network 120 represents the Internet in this disclosure. Such a network may typically include one or more microprocessor based computing devices, such as application specific processors of, computer (PC) workstations, a smartphones and servers.

“Computer,” as referred to herein, general refers to any computing device that includes a processor. “Processor,” as used herein, refers generally to a computing device including a central processing unit (CPU), such as a CPU 145. A CPU generally includes an arithmetic logic unit (ALU), which performs arithmetic and logical operations, and a control unit, which extracts instructions (e.g., software, programs or code) from memory and decodes and executes them, calling on the ALU when necessary. “Memory”, as used herein, refers to one or more devices capable of storing data, such as in the form of chips, tapes, disks or drives. Memory, such as memory 148 may take the form of one or more media drives, random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including a processor or a computer.

The term “server,” as used herein, generally refers to a computer or device communicatively coupled to a network, such as network 120, that manages network resources. For example, a file server is a computer and storage device dedicated to storing files, while a database server is a computer system that processes database queries. A server may refer to a discrete computing device, or may refer to the program that is managing resources rather than an entire computer.

In FIG. 1, each of the elements illustrated are implemented as discrete hardware elements. As would be appreciated, the inventive system described herein utilizes terminals for inputting publication or multimedia data and distributing the publication or multimedia, such as 110a, 110b, and server 130, server 140 and the associated databases 350, 370, 380, 390 as may be embodied in this special purpose computing system, utilizing dedicated logic circuits, integrated circuits, Programmable Array Logic (PAL), Application Specific Integrated Circuits (ASIC), each of which provide outputs in responses, specific to the application herein described.

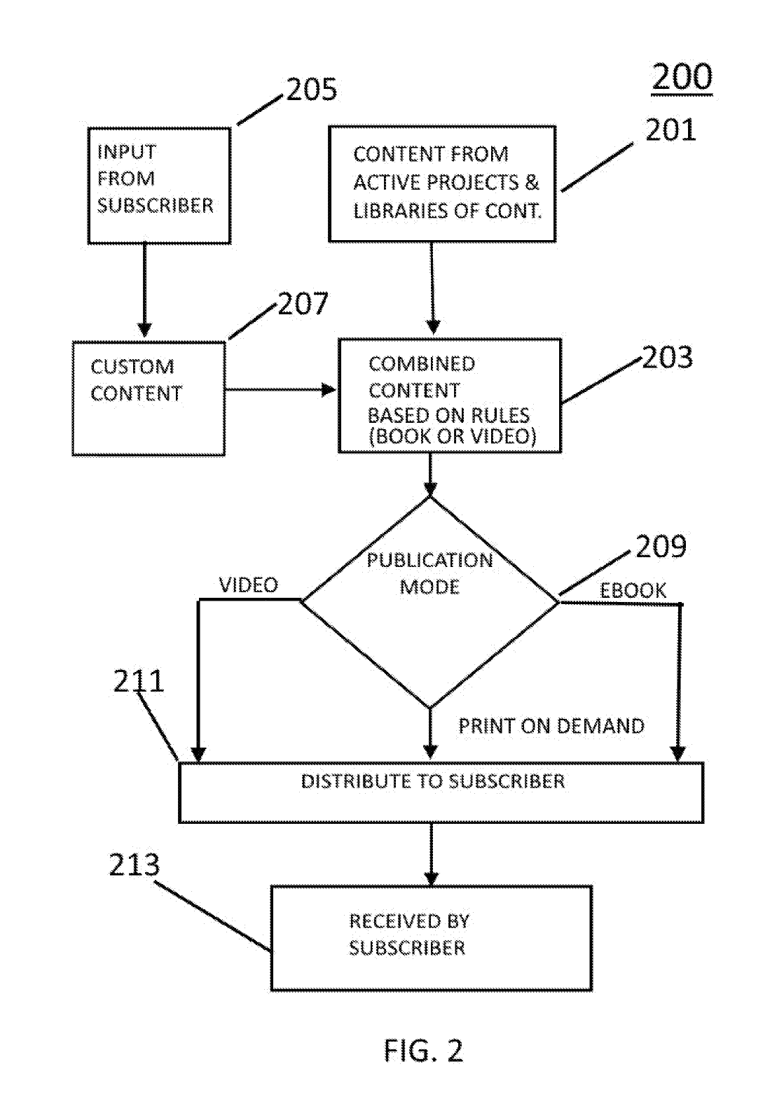

FIG. 1 system 100 and processors 140 and 106, carry out the steps of the process 200 shown in FIG. 2, within each processor, as embodied in hardware, having special purpose instructions therein or utilizing a computer having a computer readable medium, for the acquisition of particular subject matter in accordance with the profile (e.g., FIG. 4) of a user, and input from a subscriber, that desires to acquire special editions of publications or multimedia based on certain life events or issues, included in content, typically in the context of educational, social, cultural, and personal events or issues relevant to the ultimate reader or viewer.

The Internet connection 120 connects various subsystems, such as to user or subscriber terminal 110, the distribution services 196 and production services 190, and to the central site web server 130. Server 140 uses software for loading a media application having a plurality of tools into the one or more computers, such as server 140 and terminal 111, which includes a memory 113, a display 103, and optionally a keyboard 108; and using a manager tool, from the media application, loads various media content related to active products into database 350; obtaining input from the user via terminal device 110 information, as it relates to the individual for whom the book, multimedia or 3-D product will benefit; determine whether new editions of the product are required modify the current active product, and if so proceed to incorporate the changes; and to assemble the final product files; and to manage the distribution and billing of the services to the subscriber. As indicated, certain actions of the server 140 are controlled in part through the administrative terminal 111.

A rules engine 180 allows for the customization of a particular type of publication or multimedia, by integrating the subscriber's input, such as input from the records and data found in FIG. 4, e.g., the library of content database, 390 universe of related content database 370, the POS database 380, the subscriber input from terminal 110, and the publisher input from terminal 111, and when relevant other data existing in the records of the active products database 350. Based upon certain algorithms, the rule engine 180, periodically, automatically weaves in new content into existing active products (e.g., publication or multimedia), so that theses changes and on going changes, made by the user or subscriber using device 110, seamlessly integrate into the current edition of the final product. The analogy is that it inserts new pages or deletes old pages of a book, resident as an active product, as determined by the relevance of the new information and the profile of the user. Once the publication or multimedia is assembled, that is the content is fully joined, the finished product is transmitted through network 120, to a subscriber 110 or to the distribution service 196 for delivery.

Communications represented by line 115, may be of wired and/or wireless type, to provide interconnectivity between administrative terminal 111, active product database 350 and one or more resources connected via Internet 120. Alternatively administrative terminal 111 may be connected to webserver 130 via Internet 120. Communications to the Internet may in-turn be established by a wide area network, a metropolitan area network, a local area network, a terrestrial broadcast system, a cable network, a satellite network, a wireless network, or a telephone network, as well as portions or combinations of these and other types of networks (all herein referred to variously as a network and/or the Internet). The system 100 can function from any 128 bit (or higher) encryption enabled Internet enabled computer in the world equipped with a browser, such as by way of example and not limitation, MICROSOFT® INTERNET EXPLORER browser for the World Wide Web by Microsoft Corp. of Redmond, Wash.; or MOZILLA FIREFOX® by the Mozilla Corporation of Mountain View Calif.

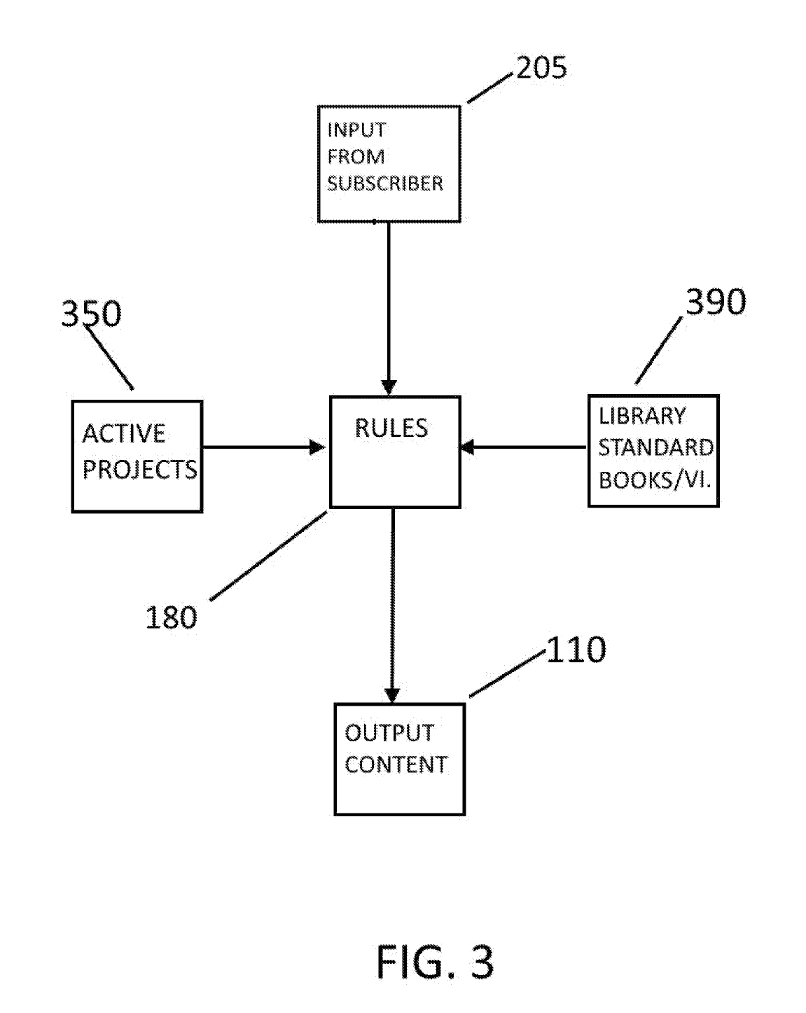

FIG. 2, FIG. 3 represent one embodiment of a method 200 for creating a customized version of a book or multimedia that includes the step of accessing content 201 (i.e., data and information from the active projects database 350, universe of related content database 370, POS database 380, and library of content 390) and using the rules 180, to combine the foregoing data. In step 203, the aforementioned from step 201 is combined with subscriber 205 generated data using terminal 110. The combined content 203 is forwarded to a publication mode 209, which, based on further input from the subscriber, determines the mode of publication, such as by way of example, an eBook, video or print-on-demand. In step 211, the media is distributed to the subscriber to be received 213 by the subscriber for the intended purpose, e.g., reading or viewing by an individual such as a child.

In an alternate embodiment, third parties may submit or may be invited to submit content for inclusion in one or more of the universe of related content 370 and library of content database 390. A third party submitter logs on to a server 130 (FIG. 1). Prior to acceptance of any submission, the submitter of content electronically accepts the publisher's terms of submission, which may include the grant of all rights, title and interest in and to the submitted content, or the grant of such other rights as the publisher requires prior to acceptance. Content submitted by third parties is processed via algorithms and rules, as may be resident in rules engine 180, and processed via CPU 145, based on publisher controlled parameters to determine and verify among other things, that the content does not contain damaging, disabling or unsuitable code or content, including but not limited to malware, viruses, or other hidden or malicious code or content, pornography, vulgarity. Content that meets the scan parameters is then stored in a content database 390. The publisher logs into terminal 111, to determine utilizing among other things, algorithms and rules, the suitability of material stored in the content database 390.

In one non limiting embodiment, the content for a book or multimedia is created or built out one time, i.e., a first edition, whereby the subscriber experience (i.e., variable), as stored in POS database 380, is accounted for, in drawing upon the library content 390, in assembling the content of the active projects 350, i.e., the first edition of the book or multimedia product. If a life change event occurs, such as a sibling birth, marriage, or even death of close one, as keyed in by reference 110a, or as reflected in POS database 380, then the new information causes the process to takes an alternate path or new branch, which deals with the particular event, in assembling a derivative publication, or edition 2, by analogy to a conventional book or multimedia product. Note that new information, subjects or material of the new content will exist in the library of content database 390, or universe of related content database 370, which may represent content analogous to a movie, or story having alternate endings, one of a multiple plotlines. The update is inserted, to augment or replace, a revised active projects 350 book or multimedia, according to the subscriber's dictates or changed status, i.e., how his/her personal profile changes. Note, that in substantive respects, the main story of a particular active project may be similar to the story of other subscribers. Essentially, if two people were to select the same life events, including the permanent ones, they would each get the same content for that revision during the period (e.g., monthly).

In another embodiment of the invention, discussion questions and topics are added to the active product content such that, by way of example, at the end of a defined period, (e.g., monthly) a parent can discuss and answer such questions with the child user. They may take the form of open ended questions such as “What would you have done if you were [the main character] faced with the challenge he faced?” When the eBook or multimedia content is electronically delivered to the user or subscriber, the questions may be answered online and then collected and shared among other subscribers to the service, such that by way of example, a parent and child can read and discuss other answers or comments to the questions or discussion points for that period (e.g., month). Under one embodiment of the invention, the parent may elect to subscribe to such discussion questions or topics or elect not to, and this would control whether such questions appeared at the end of the periodic eBook or multimedia content. The election to subscribe would be made part of the records stored in the library of content, to be added to the active products, would append specific fields to the eBook or multimedia product and allow the user to thereby interact with the product.

In one non limiting embodiment, system 100, under the process embodied in FIG. 2, method 200, utilizes a terminal 111 configured to communicate with server 140 for active product content creation, publication, and distribution that optionally works in conjunction with the production services 190 or the distribution services 196. The various software required for publication software, publication printing, 3-D printing, resides in memory 104, and works with active product content database 350. A utility software resident in memory 104 and 107, a system's design choice, permits the web server 130, to receive from the an administrative terminal 111 publication or multimedia instructions related to the creation and distribution of active products stored in database 350.

The method illustrated in FIG. 2 and FIG. 3 may be implemented in a non-transitory computer-readable medium containing instructions for execution by a processor, the instructions including accessing standard content 201 (i.e., data and information from the active projects 350 and databases 390, 370, 380, and using the rules 180 for combining the standard content, templates and the custom content generated in step 207, based on input 205 from a subscriber through device 110a, and forwarding the combined content to a publication mode 209 that based on input from the subscriber, determines the mode of publication, eBook, video or print-on-demand, via terminal 110(b), or 3-D printing.

FIG. 4, consists, by way of example, of three columns, each having significance, insofar as the user, i.e., an individual, such a child or student, to matters delineating relatively unchanging variables. For discussion purposes these are labeled, Record Of Key Parameters, 401, Record Of Key Life Objectives, 402, and Record Of Key Life Skills, 403 (collectively “POS”). The lists contained in FIG. 4 are solely representative, as depending on the particular individual, embodiment of the invention, the and actual variables used is a design choice. However, as illustrated, the category, 401, represents the fairly stable attributes of the individual for which the product is created. Category 402 represents the objective of the individual, such as might be indicted by a particular educational or vocational direction. Likewise, 403, represents, a skill that an individual might wish to attain.

By way of illustration the variables, 401, 402, and 403, such as age, education, and skills, respectively, are stored in a user specific database, referred to as a POS database 380, and used by the rules engine 180, in conjunction with universe of related subject matter content database 370 and library of content (e.g., templates and reference material) database 390, to create the book or multimedia product that resides in the active products database 350, referred to as active projects, which ultimately produce the book or multimedia products.

The variables referred to as Record Of Key Parameters, 401, Record Of Key Life Objectives, 402, and Record Of Key Life Skills, 403, are inputted at the start of project by a subscriber. A user of terminal 110 through reference device 110a, may change the variables at any time and thus affect the content of the active projects.

Although preferred embodiments include human-machine interface displays and applets that are capable of running in standard browsers, the invention may be practiced using native human machine interface applications that run directly under the host computers' operating systems (e.g., MICROSOFT® WINDOWS® operating system, UNIX® operating system, Apple™ operating system, LINUX® operating system and the like), as well as such devices as smartphones, IPad™ device (An Apple trademark), and Android™ devices (A Goggle trademark), and other personal assistant data devices.

Turning to FIG. 5, the invention allows the automatic updating and creation of a publication, multimedia or 3-D product via the architecture of system 300. System 300 includes a web crawler 320, which contains therein, a preselected list of URLs to visit, called seeds, within a subset of Internet websites, referred to as Internet of relevant material 310. Crawler 320 functions and related search software may also provide the crawled content and associated metadata (such as URL of the content, type of page, time of crawl, and so forth). As the crawler visits these URLs, it identifies all the hyperlinks in a page and adds them to the list of URLs to visit, called the crawl frontier. URLs from the frontier are recursively visited according to a set of policies determined by the administrators of system 100. As the crawler is archiving websites, it copies and saves the information as it proceeds. The archives are usually stored in a database, such as database 370, in such a way that they can be viewed, read and navigated as if they were live on a website, or optionally viewed simply as static “snapshots.”

In one non limiting embodiment, the web crawler 320 seeks out one or more websites 310 having material generally relevant to one or more active projects, associated with one or more individuals, for the creation of the books and multimedia hereinbefore described and stored in active projects database 350. Upon retrieving subject matter material, such as a document, from the Internet of relevant material 310, system 300 stores the material into a universe of related subject matter content database 370. Thereafter the information in the database 370 applies a first test using comparator 303, to compare the information in database 370 to data stored in database 380, to determine if the new information contains general points of relevance to the data stored in database 380, as pertains to and described in connection with FIGS. 4, 401, 402 and 403. If there is a favorable comparison from comparator 303, then a second test, utilizing a hardware logic circuit or software instruction, determines if the new information is specifically related to a project in database 350, and if it is specifically related, the information from database 370 is used to update the project, by updating 350 the content in the active library database 390, (See, FIG. 2, 201). If the information is not specifically related the system waits to compare other information as retrieved by the crawler 320, depicted by line 308.

In an alternate embodiment, not illustrated in FIG. 5, the subject matter content database 370 is compared to both the active projects database 350 information and the library of content database 390 information, to determine if the new retrieved matter, i.e., subject matter content database 370 is relevant, before being tested or compared to the POS database 380 information to determine if it needs to be included in an updated or derivative book or multimedia version.

Returning to the framework of the architecture and system 100 and methodology as described with reference to FIGS. 2, 3, and 5, toys and other artifacts related to the production of books and multimedia, may be created, via 3-D printing, or manufactured by a third party and delivered to the subscriber, consistent with what an individual, such as the child may be reading about in a story plotline. In the embodiment of system 100, server 140 is in communication with database 390 to store patterns, i.e., 3-D graphic representations of devices, such as toys and other artifacts and information related to managing such, based upon the provisions of an associated plan. The active projects stored in database 350, based on the foregoing, may also include 3-D representations of products that may be produced via computer aided manufacturing, or 3-D printing, as illustrated by reference to manufacturing services 191 (FIG. 1).

With reference to the foregoing descriptions related to FIGS. 1, 2, 3, 4 and 5, one embodiment of the invention is a method for creating a book, multimedia presentations or 3-D printed products, via network 120 (FIG. 1) and architecture shown in FIG. 5, including the steps of: accessing one or more user computers in a network for purposes of obtaining input from a user via terminal device 110, and other relevant related content via a crawler 320, and storing the content in a library of content 390 and universe of related subject matter content 370, respectively; loading a media application having a plurality of tools into the one or more user computers, such as server 140 and terminal 111; using a manager tool from the media application to load various media content related to active projects into database 350; obtaining input from the user via terminal device 110 information, as it relates to the individual for whom the book, multimedia or 3-D product will benefit, by way of example and not limitation, age, environment, demographic, cultural base, life change events, current events; providing templates for the create of pages with specific layouts; determining if a revision of the active projects is necessitated by new information; assembling the media data having new information into one or more of text documents, graphic images, multimedia images, audio or data files or 3-D printer files; providing plug-ins for each type content that may be required to display the content on various devices, such as computers, smartphones or PDAs; providing converters for displaying the book or multimedia in a graphical user interface; and updating the book, multimedia or 3-D printer content, by searching additional resource information; permitting collaboration among other users, such as among other children or their parents, teachers or mentors, and providing automatic active project updating using searched resource information, obtained from the crawler or other Internet search services.

While the foregoing invention has been described with reference to the above embodiments, additional modifications and changes can be made without departing from the spirit of the invention.

I claim:

1. A computer system for creating one of a book, multimedia presentation or 3-D printed product, comprising: one or more computers, and one or more storage devices containing databases associated thereto, including a user specific database; an active projects database; a library of content information database; a related content database; a web crawler to search and store new information into the related content database; a processor for determining if the new information, based on data in the user specific database, must update the active projects database; a manager tool to load media content for creating from an updated active projects database, one or more of a book, multimedia presentation or 3-D printed product; a media application having a plurality of tools for the one or more computers to assemble, display and distribute one of the book, multimedia presentation or 3-D printed product.

2. The computer system in claim 1, wherein the web crawler visits one or more websites having subject matter material relevant to one or more active projects associated with one or more individuals.

3. The computer system in claim 1, includes a comparator to compare the retrieved subject matter to the information in the active products database.

4. The computer system in claim 3, includes one of a logic circuit or software instruction to determine if the subject matter is related to information in the active products project in database.

5. The computer system in claim 1, wherein the web crawler provides retrieved subject matter and stores the subject matter into a database.

6. A method for creating one of a book, multimedia presentation or 3-D printed product, comprising the steps of: storing user specific data in a first database; storing a library of content information in a second database; searching and acquiring additional resource information and storing the resource information into a related information database; determining if the information in the related information database, based on the data in the first database, requires updating an active projects database; updating the active projects database; assembling an active project based on the data in the active projects database into one or more of a book, multimedia presentation or 3-D printed product.

7. The method of claim 6, wherein the library of content database includes one of reference material and templates.

8. The method of claim 6, further includes a web crawler to add information into the related information database.

9. The method of claim 8, wherein the web crawler allows for automatic active projects updating, using searched resource information.

10. The method of claim 6, including permitting collaboration among one or more of children, parents, teachers, mentors and employers.

11. The method of claim 6, including discussion questions added to the active projects database.

12. The method of claim 6, further includes providing plug-ins for each type content required to display the content on computers, smartphones or PDAs.

13. The method of claim 6, further includes providing converters for displaying the book or multimedia in a graphical user interface.

14. The method of claim 6, further includes creating a customized version of a one of the book or multimedia or 3-D printed product, including the steps of: accessing standard content, library content, custom content from the active projects database.

15. The method of claim 6, further includes applying one or more rules and input from a subscriber for combining the standard content, library content, and custom content into one of a book or multimedia or 3-D printed product.

16. The method of claim 6, further includes determining a mode of publication of media publication, displaying the media publication in the selected mode.

17. The method of claim 6, further includes creating the content for one of a book or multimedia which is slotted into the content of the active projects.

18. A non-transitory computer-readable medium for execution by a processor comprising code for: (a) creating one of a book, multimedia presentation or 3-D printed product; (b) storing user specific data in a first database; storing content related to the user specific data in a second database; (c) storing a library of content information in a third database; (c) loading a media application having a plurality of tools into one or more computers; (d) using a manager tool from the media application to load media content for creating an active products into an active projects database from user specific data and library of content information; (e) updating content of one of the book, multimedia or 3-D printed product, by searching additional resource information; (f) assembling the active projects into one or more of a book, multimedia presentation or 3-D printed product.

19. A non-transitory computer-readable medium in claim 18, further including code for a document control module for generating separate parts of a document.

20. A non-transitory computer-readable medium in claim 18, further code to edit an active project, wherein the edit relates to one or more of periodic changes in a reader's maturity, age, physical growth, psychological growth, emotional status, intellectual status, subject matter, occupation goals, vocation goals.
